(19) United States
(12) Patent Application Publication
(10) Pub. No.: US 2020/0111092 A1
(43) Pub. Date: Apr. 9, 2020

(54) FINANCIAL DERIVATIVE SMART CONTRACT EXECUTION PLATFORM, SYSTEM AND METHOD

(71) Applicant: Luther Systems, London (GB)

(72) Inventors: Samuel WOOD, London (GB); Hossein Kakavand, London (GB)

(21) Appl. No.: 16/672,386

(22) Filed: Nov. 1, 2019

Related U.S. Application Data
(63) Continuation of application No. PCT/US2018/030734, filed on May 2, 2018.
(60) Provisional application No. 62/500,077, filed on May 2, 2017.

(51) Int. Cl. G06Q 20/38; G06Q 40/06; G06Q 40/04

(52) U.S. Cl. CPC G06Q 20/3829; G06Q 20/389; G06Q 40/06; H04L 2209/56; H04L 2209/38; G06Q 2220/00; G06Q 40/04

(57) ABSTRACT

A system and method for processing and executing financial derivative contracts between one or more counterparties uses a distributed blockchain ledger and a smart contract and without the need for a trusted third party or intermediary. The system may have a plurality of distributed ledger nodes that each host the distributed ledger and the smart contract that are coupled to a management computer system that facilitates the processing and executing of the financial derivative using the distributed ledger and the smart contract.

### PRIORITY CLAIMS/RELATED CASES

This application is a Continuation Patent Application, and claims priority to International Patent Application No. PCT/US2018/030734, filed May 2, 2018, which claims the benefit under 35 USC 119(e) to U.S. Provisional Patent Application No. 62/500,077, filed May 2, 2017, now expired, both titled “FINANCIAL DERIVATIVE SMART CONTRACT EXECUTION PLATFORM, SYSTEM AND METHOD”, the entirety of which is incorporated herein by reference.

### FIELD

The present system and method relate to the processing, storage, execution, and management of financial derivatives contracts. The present system and method utilize technology from the following fields, digital time-stamping, encryption, distributed storage, distributed ledger technology, and smart contracts.

### BACKGROUND

As Blockchain Technology expands in scope and commercial adoption, there is a need for a set of agreed upon and widely adopted set of standards that will govern the technological development as well as commercial governance of Blockchains.

Derivatives are a widely adopted means of risk transference across financial markets, primarily concerning exposures to interest rate, credit and foreign exchange risks. The notional trade in the derivatives market ranges in the hundreds of trillions of dollars annually across the globe.

The operational infrastructure and trading mechanisms for the matching, execution and post trade treatment of derivatives contracts has been developed over a number of decades by a large number of technology, operational, and legal groups. Major progress has been made towards the standardization and consolidation of many parts of the derivative contract transaction management pipeline, however it still remains fragmented and not fully standardised. These inefficiencies create considerable friction and opacity in the market, resulting in high transaction fees, considerable costs to the various participants in the market, and the prevalence of intermediaries, which further exacerbates these problems and inefficiencies.

Blockchain technology is an emerging new technology that has great potential in addressing elements of the inefficiencies and friction within these markets (The Blockchain Revolution: An Analysis of Regulation and Technology Related to Distributed Ledger Technologies”, preprint, H. Kakavand, N. Kost De Sevres, Commissioner B. Chilton.) Blockchain technology can provide a technical solution with increased security, transaction processing and settlement speeds, while reducing counterparty risk and compliance and auditing costs to the technical problems of existing derivative trading systems described above.

One aspect of Blockchain technology that is particularly suited to address the problems of existing derivative trading systems and improve the execution of derivative contracts is Smart Contracts. Smart Contracts are computer programs stored on the Blockchain that facilitate, verify, or enforce the negotiation or performance of a contract, or that make a contractual clause unnecessary as contracts are automatically executed when pre-programmed conditions are satisfied. Smart contracts eliminate ambiguity regarding the terms of agreements and reduce the reliance on external dependencies.

Blockchain technology provides a number of commercial and technology benefits including, reduced Back Office Costs, increased security and lower security technology costs, increased transaction processing and settlement speed, reduced counterparty risk and increased liquidity, reduced technology integration and resources costs, and reduced compliance and auditing costs.

Blockchain technology strengthens trust-based contracts by adding rules that are defined and enforced programmatically (Pilkington, Marc, “Blockchain Technology: Principles and Applications,” page 15 (citing Kwon, J. (2014). Tendermint: Consensus without Mining. White paper.). Technical benefits of blockchain technology include decentralization, immutable transaction log and ledger, and a standardized contract execution platform.

Interest Rate Swaps (IRS) are financial derivatives designed to swap exposure to changes in interest rates over time for a fixed cash flow stream (FIG. 1). Counterparties (CP) agree on a notional amount and periodically exchange a fixed % of notional (fixed leg) with a % of notional determined by the prevailing interest rate at time of exchange (floating leg). In the event of default of a counterparty, all future transactions are terminated.

A plain vanilla interest rate swap has a number of high level variables that describe its execution schedule (FIG. 2) and parameters. These variables include: Counterparties: The legal entities engaged in the derivative contract.
Notional: The principal amount which the fixed and floating rates are applied to.
Term: The total time length of contract.
Calculation Frequency: The frequency calculations are made.
Payment Frequency: The frequency payments are made.
Counterparty identities: References to the counterparties involved in the contract.
Fixed rate: Percent of the notional paid by the fixed leg.
Floating rate: Rate indexed by the reference rate (e.g., LIBOR).
Reference rate: The prevailing interest rate reference captured on calculation dates.
Schedule adjustments: The day count convention, calculation date, payment date, holiday date adjustments.
Currency: The currency of the cash flows in the contract.

A plain vanilla interest rate swap includes the following variables, which belong to a fixed or floating leg:

Fixed Leg:
ID, trade date, trade date adjustment, effective date, effective date adjustment, end date, end date adjustment, calculation frequency, calculation date adjustment, payment frequency, payment date adjustment, reset dates, fixing dates, notional, currency, floating rate index curve, floating rate tenor, day count convention.

Floating Leg
Id, trade date, trade date adjustment, effective date, effective date adjustment, end date, end date adjustment, calculation frequency, calculation date adjustment, payment frequency, payment date adjustment, notional, currency, fixed rate, day count convention.

Current IRS processing systems receive these inputs from users (counterparties) as standard templates and translate the template into standardized Financial Product Markup Language (FPML) messages.

A simplified vanilla IRS model uses the following formula to calculate floating payments, based on a several day count fractions, as follows:

Floating Payment=Notional*Floating Rate(Captured on ResetDate)*DayCountFraction

Y2=2016; Y1=2016; M2=10; M1=7; D2=16; D1=15;

Actual Days=(31−15)+(31)+(30)+(16)=93

Actual Year (2016)=365

Actual/Actual

Day CountFraction=93/365=0.2547

Actual/365

Day CountFraction=93/365=0.2547

Actual/360

Day CountFraction=93/360=0.2583

30/360

Day CountFraction=[2016−2016)+30*(10−7)+(16−15)]/360=91/360=0.2493

In general, a Blockchain is a digital platform that stores and verifies the entire history of transactions between users across the network in a tamper- and revision-proof way. It is also the underlying database structure for digital currency transactions including in the Bitcoin and Ethereum networks. The paper—Bitcoin: A peer-to-peer electronic cash system” (Nakamoto, 2009) is incorporated into this application by reference. Transactions between users or counter-parties are broadcast across the network and are verified by cryptographic algorithms and grouped into blocks. Each block is subsequently verified by the network and added to the Blockchain and blocks are cryptographically chained to each other to prevent alteration. For example, each node participating in the Bitcoin network has its own copy of the Blockchain, which is synchronized with other nodes using a peer-to-peer protocol (“Proof of Stake versus Proof of Work”, White Paper, Bitfury Group Limited, Sep. 13, 2015). This “removes the need for a central authority and thus for participants to have confidence in the integrity of any single entity.” (“Innovations in payment technologies and the emergence of digital currencies”, Robleh Ali, 2014) Blockchain technology enables multiple organizations and groups within an organization to efficiently process transactions and securely reach consensus without the requirement of a third party (“The Blockchain Revolution: An Analysis of Regulation and Technology Related to Distributed Ledger Technologies”, preprint, H. Kakavand, N. Kost De Sevres, Commissioner B. Chilton).

We describe key blockchain concepts and terminology below.

Transaction: Users submit transactions to nodes using a client. In Bitcoin based technologies, a transaction is a signed message that includes a script which is executed by nodes to transfer value from one address to another. In other blockchains including Ethereum and Hyperledger fabric, a transaction is a signed message used to either deploy a smart contract or send a message to a smart contract which uses the payload to execute a function and update the blockchain state. Nodes validate and disseminate transactions using a peer-to-peer protocol so that every node receives every valid transaction. Transactions are then grouped together in blocks which are also disseminated through the network, validated, and added to the blockchain. A transaction is said to be confirmed if it is included in a block which has been added to the blockchain.

Oracle: Where a smart contract's conditions depend upon real world data (e.g., the price of a commodity future at a given time), agreed-upon outside systems called “oracles” can be developed to monitor and verify prices, performance, or other real world events. An oracle is an off-chain service (not part of the blockchain) selected by the counterparties that is responsible for sending event update transactions to the smart contract.

On chain Code: Code that is executed entirely on the blockchain. This code is written in a smart contract language such as Solidity in Ethereum or chaincode (Go) in Hyperledger fabric. Each node runs the on chain code to validate transactions and maintain the integrity of the blockchain.

Off chain Code: Code that is executed entirely off the blockchain. In other words, code that is not “on chain code”.

Query: Clients can send query messages to a node to lookup the information stored on the blockchain. For example, a client can issue a query to retrieve the latest state associated with a smart contract. The node does not necessarily need to communicate with other nodes to answer this query, in some cases it can use its own locally maintained blockchain that is synchronized with the network to retrieve the requested state.

Node: A Blockchain is maintained by software that runs on a computer called a node or peer. Each node is connected to the Blockchain network and can submit and receive transactions. Each node participating in the Bitcoin network, for example, has its own copy of the Blockchain, which is synchronized with other nodes using a peer-to-peer protocol.

Network: Organizations and possibly individuals maintain computer systems called nodes, these nodes run Blockchain software to communicate with each other and form a Blockchain network.

Submit Transaction: Users submit transactions to the Blockchain by using a client that sends them to nodes on the network who subsequently disseminate them to all other nodes on the network.

Transaction Validation: Nodes on the Blockchain network receive, process and cryptographically validate each transaction. The network ignores invalid transactions.

Blocks: Nodes collect and group valid transactions together into a bundle known as a block. Blocks must follow a predetermined set of rules for them to be valid. For example, they must not exceed a maximum size in bytes, contain more than a maximum number of transactions, and must reference the most recent valid block. Nodes validate a block and its transactions and then run a consensus protocol to agree on the latest block.

Blockchain: Each new block contains a reference to the most recent valid block and is attached to that block. I.e., it is placed after that block in the database, forming a “chain of blocks”.

In distributed systems, multiple processes communicate to enable system operation. It is possible for faults to occur anywhere throughout a distributed system, for example processes may crash or adversaries may send malicious messages to processes. Distributed systems use consensus protocols to achieve reliability despite faults. Processes execute a consensus protocol so that they reach agreement within a certain period of time. For example, in Bitcoin, nodes execute a proof-of-work consensus protocol to reach agreement on the next valid block and blocks are generated roughly every 10 minutes. An adversary who injects malicious data into the system can trigger faults known as “Byzantine faults” where multiple processes receive conflicting information. Byzantine Fault Tolerance (BFT) refers to consensus protocols that achieve consensus in systems with Byzantine faults. BFT is a well understood distributed systems problem within computer science and implementations have existed for several decades (Lamport, Leslie, Robert Shostak, and Marshall Pease. “The Byzantine generals problem.” ACM Transactions on Programming Languages and Systems, 1982).

Smart contracts are computer protocols that facilitate, verify, or enforce the negotiation or performance of a contract, or that make a contractual clause unnecessary. Smart contracts usually also have a user interface and often emulate the logic of contractual clauses.

To develop a smart contract, parts of the terms that make up a traditional contract are implemented in software code and uploaded to the Blockchain, producing a decentralized smart contract that does not rely on a third party for recordkeeping or enforcement. Contractual clauses are automatically executed when pre-programed conditions are satisfied. This eliminates ambiguity regarding the terms of the agreement and disagreement concerning the existence of external dependencies.

Blockchain technology offers solutions for the inefficiencies in the management of financial transactions. Blockchain technology can provide the following benefits when applied to financial transactions.

Reduced Back Office Costs: A plurality of contracts coexist on single Blockchain, reducing infrastructure costs. This consolidation replaces antiquated manual processes that can take too long and removes intermediaries, which lowers overall back office costs, improves efficiency and speed.

Increased Security & Lower Security Tech Costs: Blockchain architectures combine modern cryptography and distributed systems to maintain an immutable ledger. Removing intermediaries lowers potential security concerns from hacking to corruption resulting in lowered security costs.

Increased Transaction Processing & Settlement Speed: Counterparties co-exist on the same Blockchain network which reduces transaction settlement times to near instantaneous. Faster processing times allow accurate, near real-time, feedback on risks and exposures.

Reduced Counterparty Risk & Increased Liquidity: Reduced settlement time reduces counterparty risk and provides speedy access to capital/funds.

Reduced Technology Integration & Resources Costs: Permissioned or permission-less ledgers as infrastructure can be shared across multiple institutions and reusable across various asset classes. Human-in-the-loop processes are automated/optimized as smart contracts which reduce resource costs.

Reduced Compliance & Auditing Costs: Blockchain technology enables Automated contract execution, enforcement and audit trail, only compliant transactions are validated. Regulators can verify compliance in real time reducing supervisory costs.

Blockchain technology strengthens trust-based contracts by adding rules that are defined and enforced programmatically (Pilkington, Marc, “Blockchain Technology: Principles and Applications,” page 15 (citing Kwon, J. (2014). Tendermint: Consensus without Mining. White paper.). Three key technical benefits provided by most blockchain platforms are the following:

Decentralization: Peer-to-peer blockchain protocols enable counterparties to engage in contracts without requiring trust in each other or a trusted third party. In some applications the function of a trusted intermediary can be replaced by a blockchain network. Disintermediation through decentralization can reduce costs and improve operating efficiency. E.g., through reduced settlement times.

Immutable Transaction Log: Blockchain protocols use modern cryptography to maintain a distributed ledger that records every transaction in a tamper-proof way. Every node within the network stores the entire ledger with timestamps. This facilitates detection of contract execution errors, node failures and malicious tampering.

Standardized Contract Execution Platform: Blockchain offers a shared infrastructure for smart contract execution for an enterprise consortium. Standardization of smart contract templates and their execution can reduce operating costs by easing cross-organizational interoperability for multiple asset classes. In some cases compliance logic can be added to the smart contract which further reduces auditing costs.

What is needed is a financial derivative management system that leverages the advantages of smart contracts and a blockchain architecture to reduce costs, improve operating efficiency, and increase security.

### BRIEF DESCRIPTION OF THE DRAWINGS

For a more complete understanding of the disclosure, reference is made to the following description and accompanying drawings, in which:

FIG. 1. is an indicative diagram representing the different cash flows in a vanilla interest rate swap between two counterparties.

FIG. 2. is a timeline of part of the schedule of events in a vanilla IRS.

FIG. 3. is a system diagram of a Blockchain network. Organizations run validator nodes that communicate in a peer-to-peer way to construct and maintain the integrity of the blockchain. Clients connect to validators on behalf of users to submit transactions and query the blockchain.

FIG. 4. is a flowchart of the high level process of executing IRS on the blockchain. This version of the process does not use an oracle but instead has both counterparties send the update events directly to the chaincode.

FIG. 5. is table with the high-level steps in the process of executing an IRS on the blockchain. This version of the process does not use an oracle but instead has both counterparties send the update events directly to the chaincode.

FIG. 6. is table with an example segment of a BCML object generated from an FPML file and converted to JSON.

FIG. 7. illustrates the Block View user interface on the Luther platform native application.

FIG. 8. illustrates the Swap View user interface on the Luther platform native application.

FIG. 9. illustrates the New Swap View user interface on the Luther platform native application.

FIG. 10. illustrates the execution process broken down by functions executed on/off the blockchain.

FIG. 11. illustrates the pseudocode for an initial prototype of the oracle.

FIG. 12. illustrates the pseudocode for an initial prototype of the IRS chaincode that is executed on a Hyperledger fabric blockchain.

FIG. 13. illustrates an example Derivative Management System Environment.

FIG. 14. illustrates an example Derivative Management Server.

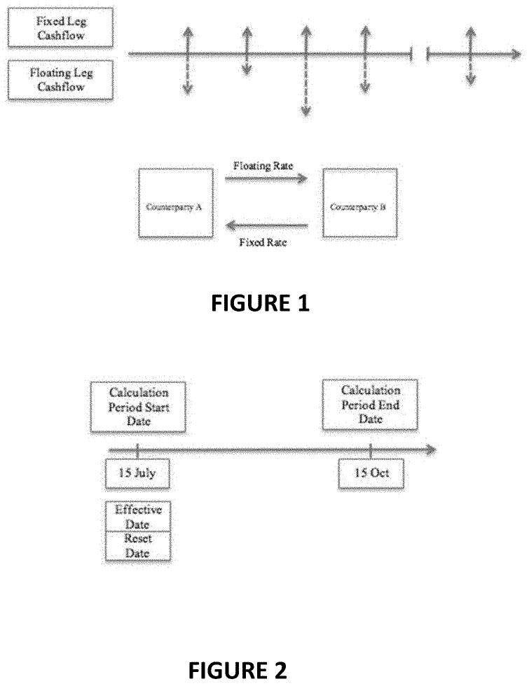

### DETAILED DESCRIPTION OF ONE OR MORE EMBODIMENTS

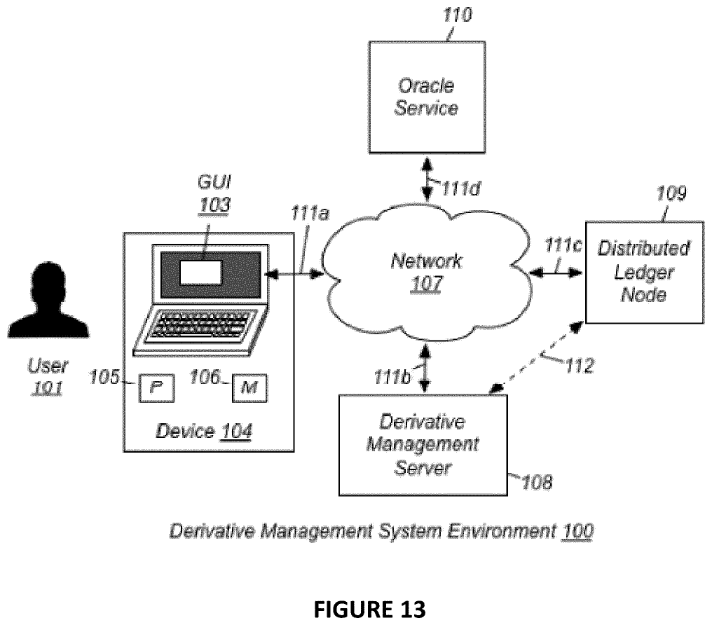

The arrangement in FIG. 13 shows an exemplary arrangement of a preferred embodiment. In this embodiment, there is at least an environment 100 consisting of a user 101 using a device 104 which interacts with a Derivative Management Server (server) 108. The server 108 is connected to a network 107 using an interface 111b. The device 104 is a computer consisting of at least a processor 105 and memory 106. The user interacts with the server 108 by using a GUI 103 running on the device. The device communicates with the server 108 over a network 107, using a network interface 111a. The server 108 may use an authenticated client communicate with a Distributed Ledger Node (node) 109 that is connected to the network 107 using a network interface 111b. The server 108 and node 109 may be physically located within one or more data centers. Nodes 109 provide services for authenticated clients to access and modify a distributed ledger. Each node 109 has a blockchain component that include a blockchain based distributed ledger onto which a plurality of transactions about each financial derivative are stored and the smart contract in a irreputable manner. The Oracle Service (oracle) 110 uses an authenticated client to communicate with a node 109 possibly over a network 107 using an interface 111d. Oracles 110 provide input data for smart contracts that are subsequently processed by the blockchain network. The oracle 110 may communicate with a node 109 through an interface 113 that is not directly connected to the network 107. The server 108 may communicate with a node 109 through an interface 112 that is not connected to the network 107. One or more devices 104, servers 108, nodes 109, and oracles 110 are connected to a network 107 to establish a Derivative Management System Environment. In a preferred embodiment, each counterparty 101 has an associated device 104, server 108, and node 109.

The system 100 shown in FIG. 13 may use the nodes 109 and the management server 108 to negotiate/process a financial derivative contract with one or more counterparties using the distributed ledger and a blockchain smart contract. In some embodiments, the system 100 may be used to simultaneously negotiate/process and executes financial derivative contracts between a plurality of possibly different counter parties using the distributed ledger and a blockchain smart contract.

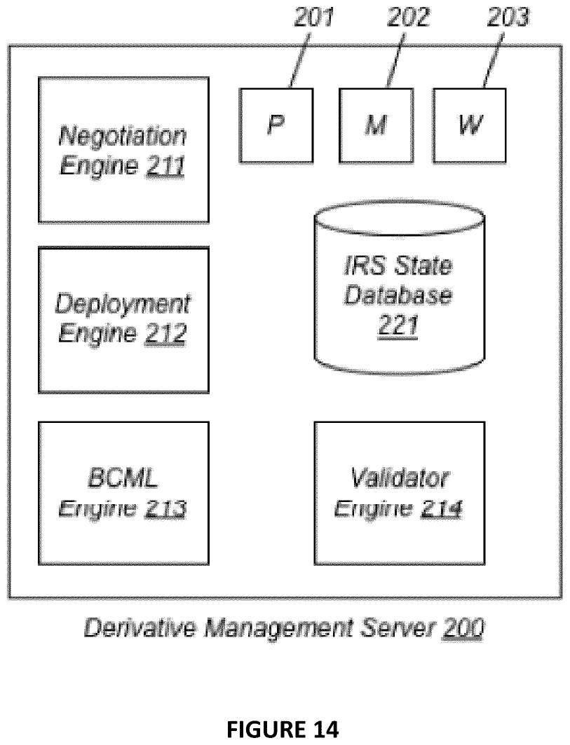

The arrangement in FIG. 14 illustrates the elements in the Derivative Management Server 200 in a preferred embodiment. The server consists of at least a processor 201 and memory 202, as well as multiple engines 211-214 and database 221. The engines communicate with each other, the databases, and other hosts on the network, to perform derivative management functions. The server stores and has access to at least one public-private key pair, stored in a data structure called a wallet 203.

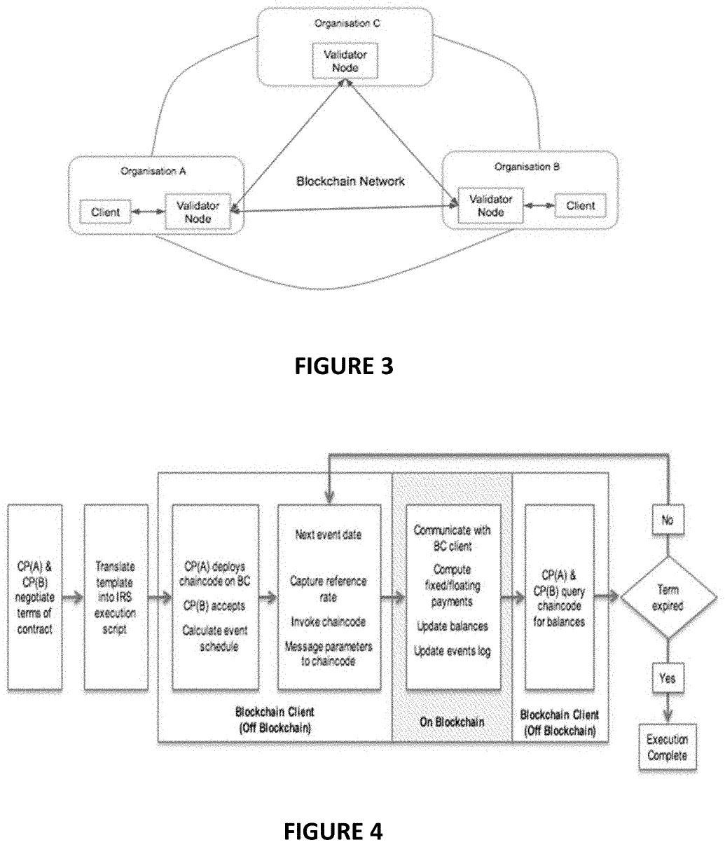

In a permissioned configuration, organizations run multiple Distributed Ledger Nodes 109 on a private network that requires restricted access (see FIG. 3). Peer nodes, also referred to as distributed ledger nodes or validators, directly communicate in a peer-to-peer way to disseminate all of the transactions and build and maintain the blockchain. Clients are authenticated applications that provide an interface to the blockchain for other applications. A client connects to one or more peers and can deploy smart contracts, submit transactions and query the blockchain. Derivative Management Server 108 engines use Blockchain clients to perform these functions. Peer nodes and clients are themselves authenticated using an agreed upon membership service which ultimately dictates who has access to the blockchain network.

Validators maintain the integrity of the blockchain and use new transactions to execute smart contracts. Blocks contain data including a set of transactions, a reference to the previous block, and a “state hash” which is the result of each smart contract executing its relevant transactions as described in detail below. Peers disseminate blocks to one another and use a consensus protocol (e.g., PBFT, or Nakamoto consensus (Bitcoin: A Peer-to-Peer Electronic Cash System, Satoshi Nakamoto 2008)) to reach agreement as to which block to add to the top of the blockchain. Only valid blocks are accepted and added to the blockchain data structure after the network has reached consensus.

State is the data, or values of the variables, stored within a smart contract. Validator nodes maintain the blockchain data structure which contains transactions and their payloads. When a smart contract is deployed it is assigned a unique ID and every validator begins executing it locally. When a node receives a new block it takes the transactions and uses the ID to pass them to the relevant running smart contract for execution. The result of this execution is that the smart contract updates its local variables, or state. A state hash is a hash over all of the variables across all of the running smart contracts. Each block includes a state hash which is the result of hashing the entire “world” state after executing all of the transactions within that block. The state hash contained within the block is compared against the state hash computed by each validator to ensure that consensus is reached on the execution of the block's transactions. In this way, although the state hash is included directly within the blockchain data structure, the contract state itself is not stored in the blockchain data structure per se—it is a function of applying the transactions to the running smart contracts.

The actual state values are available at any time by using a blockchain client. The client sends a query message with a specified contract ID to a node who then relays this request to the running smart contract. The node then relays the response to the client.

Processing and executing Interest Rate Swaps on the blockchain as smart contracts has a number of advantages that can ultimately improve efficiency and lower costs. Specifically,
Transaction settlement is moved to near instantaneous;
The need for reconciliation is eliminated as users share common source of truth;
Reporting is more efficient as users share common transaction templates and data standards;
Regulators can participate directly on the blockchain network and have real time access to transactions;

This results in considerable cost savings, estimated at billions of dollars annually [Oliver Wyman, Goldman Sachs reports].

The Interest Rate Swap smart contract life-cycle involves 4 stages:

First, users 101 interact with the Derivative Management Server 108 via a GUI 103 to create, negotiate, and agree on the details of the IRS contract. This negotiation process is performed by the Negotiation Engine 211. The contract details are represented via a standardized contract template which is generally a variation of the ISDA master agreement. The contract template then gets translated by the BCML Engine 213 into a standardized digital representation of the contract, as a Financial Product Markup Language file or FPML for short.

The Deployment Engine 212 deploys the contract to the Blockchain, and the on-chain code then generates the contract execution schedule of events, including payment schedules, rate look up dates, date adjustments and other parameters of the swap contract. The Blockchain then communicates this schedule to the Oracle Service (oracle) 110.

Third, once the oracle receives the schedule of events, it proceeds to execute the contract according to the contract schedule of events, by communicating individual events to the on-chain smart contract. The Validator Engine 214 queries the Blockchain to verify the events were executed and stores the processing history in the IRS State Database 221.

The Oracle also communicates with the outside world through a designated API used to make requests for information externally, and to communicate unscheduled events, such as default events, to the Oracle. The Oracle acts as buffer between the outside world and the Blockchain and also coordinates the timing of the execution of events on the Blockchain.

Fourth and finally, the Blockchain permanently stores the original contract as well as records and stores the details of every execution step with precise time stamps. The distributed ledger, as is known, cannot be tampered with, so that the original contract and the details of the execution steps cannot be repudiated by any of the counterparties.

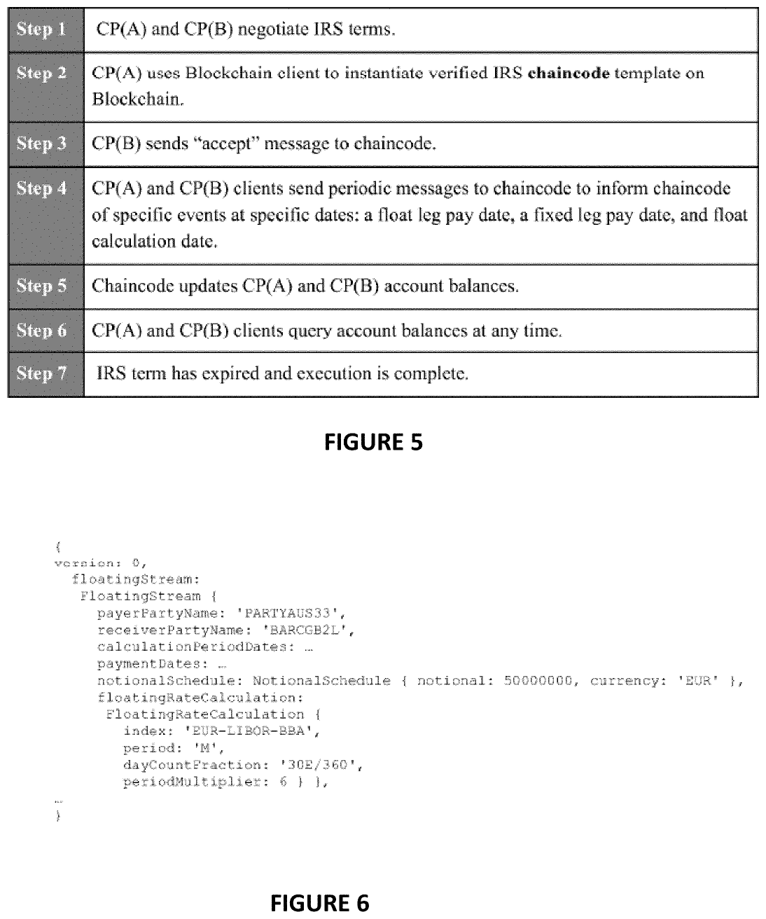

Several variants of this process are possible, depending on the requirements of the counterparties. For example, FIG. 4. and FIG. 5. describe this process with the addition that the Oracle functionality is performed directly by the counterparties.

The disclosed systems have simplified the workflow for the processing and execution of IRS transactions on the blockchain. One embodiment described in this document specifically uses Hyperledger fabric, an open source project that provides infrastructure for permissioned Blockchains, although it is possible for this process to be implemented on a variety of different Blockchain infrastructures.

Blockchain Markup Language, BCML, is a message format internal to the disclosed platform (known as the Luther Platform) that facilitates the creation, execution and storage of smart contracts. In this implementation we have specialized the BCML to the implementation of

IRS based on FPML. BCML contains all the parameters and values contained in FPML, in addition it stores the pending event list, the past event list, counterparty's account balances and net payment amounts. Also, it can be exported into JSON and Google protobufs message formats. FIG. 6. includes a segment from an example BCML object converted to JSON. All of the components within the system interact via messages that contain BCML.

In one embodiment the system consists of 4 main components, described below.

Blockchain Infrastructure Component: In one embodiment the system is composed of several Hyperledger fabric services to be running with at least 1 peer. The ultimate Hyperledger fabric configuration in terms of the number of peers and access control policy will depend on the requirements of the customer, although the native application (desktop/mobile), the oracle and chaincode processes must all be accessible to/from the peers. All the peers must also have connectivity to a membership service which is responsible for key management and access control to the Blockchain network.

In one embodiment we ran version 0.61 of Hyperledger fabric on our local machines in what we refer to as the development configuration. The development configuration runs Hyperledger fabric in development mode with certain security features disabled. This requires running the membership service, peer service, and a chaincode application for each IRS instance which connects to the peer. Note that the chaincode applications need to be started manually in the debug configuration before a deploy occurs. Membership service must also be running in this configuration although it is not managing keys. We ran these applications within a Virtual Machine (using VirtualBox) using the project's official Vagrant image. For the initial experiments we ran the VM on the same hosts as the native application. In production environments the Hyperledger fabric services run on separate machines from the native application and multiple organizations run several peers.

Native Application Component: In one embodiment counterparties interact with the system via a native application that they download and execute. This application subsequently sends and receives messages from the blockchain using a hyperledger client library. The client library provides a RESTful JSON API to interface with the Blockchain over HTTPS.

The native application is built on the Electron 1.3.5 framework developed by Github. Electron enables us to easily write native cross-platform JavaScript applications that run on both Windows and Mac OSX operating systems. The native application consists of a frontend and backend component where the backend is written in NodeJS and the frontend uses the Angular 1.5 framework. The UI makes heavy use of Google's UI/UX material design framework. The UI frontend uses the blockchain client to periodically poll for new blocks. Upon discovery of a new block the client fetches the block details along with all its transaction details. The fetched data is then populated in the UI dynamically to reflect the updates. If a transaction includes an IRS deployment or update then either a new IRS is added to the list of all IRS on the blockchain or the existing IRS is updated in the UI. This dynamic approach enables users to see events being removed from the pending list to the past events as they are executed in real time.

Oracle Component: In one embodiment the oracle service is a NodeJS application that uses the same blockchain client as used in the native application. The oracle service listens for new blocks and upon receiving a new block it inspects the transactions for deploy messages. If the transaction contains a deploy message, then the oracle extracts the payload to retrieve the IRS's chaincode ID. It uses this ID to immediately issue a query on the new chaincode which returns a payload consisting of the BCML object for that newly deployed IRS.

The oracle reads the pending event list specified in the BCML object and then registers a timer for each pending event. When the timer triggers, the oracle looks up the contract details to determine what Interest Rate reference to retrieve the floating rate from. It then uses an external API to retrieve the appropriate rate and sends this rate along with the current timestamp for this rate to the IRS chaincode identified by the chaincode ID. The oracle sends this message via the blockchain client which issues an invoke or update message to the chaincode. One embodiment uses a production deployment where the chaincode verifies that this update message is signed by the oracle to ensure that an attacker does not masquerade as the oracle.

In the development configuration the oracle is bundled with the native application as a module to Electron's NodeJS backend. This eases testing and development by not requiring a separate process for managing the oracle service. In a production environment the oracle runs on a separate machine from the peers and native application (as in FIG. 13). For example, each organization may run their oracle, and the chaincode would allow reception of updates from any oracle in an agreed upon set.

Chaincode Component: In one embodiment the chaincode is code written in Go language that models an IRS smart contract and implements all of the functionality necessary for its execution on the blockchain. It is parameterized to take as an input a BCML object which it then performs the execution on. The chaincode receives events from the oracle that it uses to process the next pending event which is then placed in the event history. Every peer runs its own instance of the chaincode as a separate process. Importantly, at any time clients can issue query messages to a peer which calls the query function on the chaincode to retrieve the IRS details.

The chaincode generates a pending schedule of events that consists of 3 event types:

1. fixed rate/payment calculation,

2. float rate retrieval and float payment calculation and

3. net payment.

Events 1 and 2 include a rate and a payment amount based on that rate, period, and contract details as specified in the original FPML. Event 3 is a new event type that does not exist in the FPML. It is computed using the payment schedule (e.g., FIG. 2) that is specified in the FPML. When two payment dates co-occur then the smart contract creates a net event where one counterparty effectively makes a single payment for the difference. The net event includes the date, the net amount paid, the counterparty, and the counterparty balances. With this approach counterparties can use the blockchain as the source of truth to net in real-time.

The User Interface to the system includes 3 views:

1. Block View: designed for a system administrator with visibility into the technical details of the Blockchain

2. Interest Rate Swap View: for users to access and interact with the details of their current and past swaps contracts

3. New Swap View for users to create and upload new swaps contracts

The UI 103 dynamically updates in response to events that occur on the blockchain. For example, whenever a new block is added or an IRS event is executed then the UI immediately displays these updates to the user.

In all 3 views there is a left pane, center pane and right pane, where the left and right panes are the same across all views. The left pane has the entire list of verified blocks by the Blockchain, which holds the entire history of all transactions and contracts. Clicking on a block listed in the left pane loads the Block View in the center pane. The right pane lists all of the swap contracts on the blockchain. Clicking on a swap listed in the right pane loads the Swap View in the center pane. Lastly, the “New Swap” button at the top of the screen loads the New Swap in the center of the screen.

The fields below are described in terms of the simplified plain vanilla IRS model and will change as additional support for FPML parameters are added.

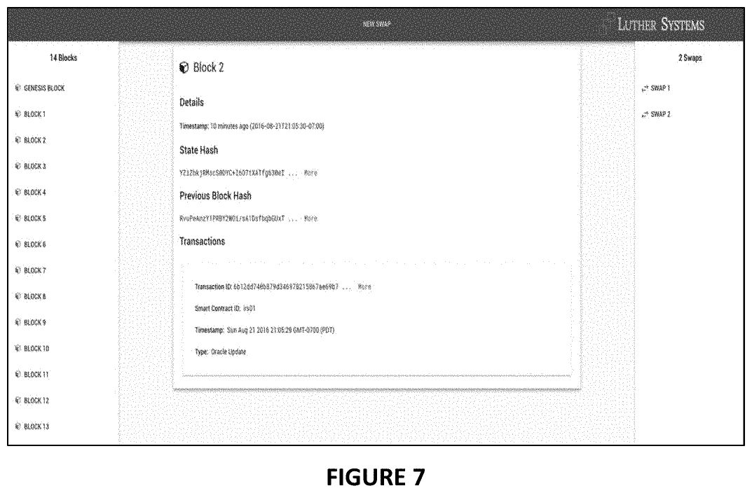

Block View: The block view in FIG. 7. lists the details of a particular block (in this case Block 2) that a user has selected, including all its transactions. Everything displayed in this view is populated directly by the native application querying the Blockchain. The details of each listed field are as follows.

Block number: block's height in the blockchain. The genesis (first) block has a height of zero.

Block timestamp: time the block was generated.

Block state hash: current block's state hash, which is a hash over all of the current state across all of the smart contracts within the blockchain, as well as the previous block hash.

Block previous block hash: hash of the previous block in the blockchain.

Transaction ID: A unique ID for the transaction.

Transaction Smart Contract ID: ID of the smart contract associated with this transaction.

Transaction Timestamp: time the transaction was generated by the Oracle.

Transaction Type: type of the transaction is either “Oracle Deploy” or “Oracle Update”.

Deploy transaction is sent by an oracle to deploy a new smart contract on the blockchain.

Update transaction is sent by an oracle to the smart contract to perform execution and update the smart contract's state.

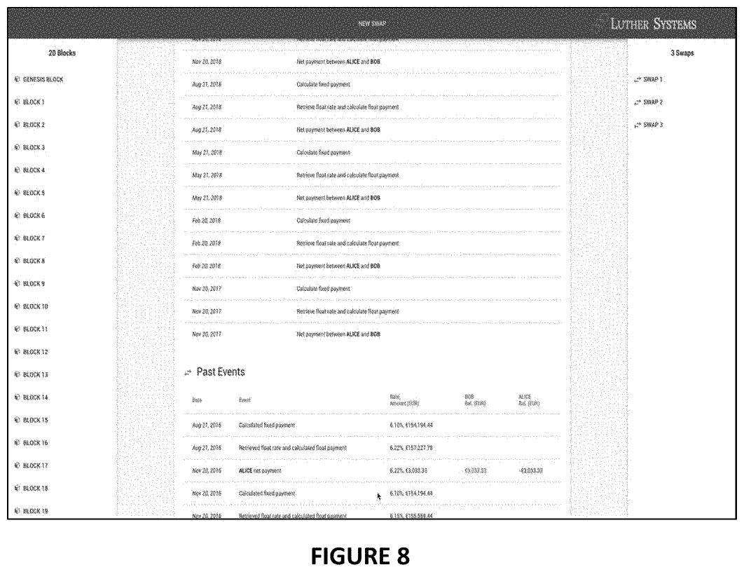

The Swap View in FIG. 8. lists all of the details associated with a particular Interest Rate Swap contract, including the past and pending events. Everything displayed in this view is populated directly by the native application which queries the Blockchain. The details of each listed field are described as follows.

Pending event: Either a net payment, fixed payment calculation, or a retrieval of the float rate and float payment calculation. Pending events are ordered by the event date in reverse chronological order. Operationally a swap contract is a series of events executed at a predetermined time schedule. The pending event list is the list of scheduled events specified by the contract to be executed throughout the contract life-cycle.

Past event: Either a net payment, fixed payment calculation, or a retrieval of the float rate and float payment calculation. Past events are ordered by the event date in chronological order. In the case of a calculation both the calculated rate and amount are included in the table. In the case of a net event, the payer counterparty, paid amount and the account balances are included.

The remaining fields have the same descriptions as those described in the New Swap View.

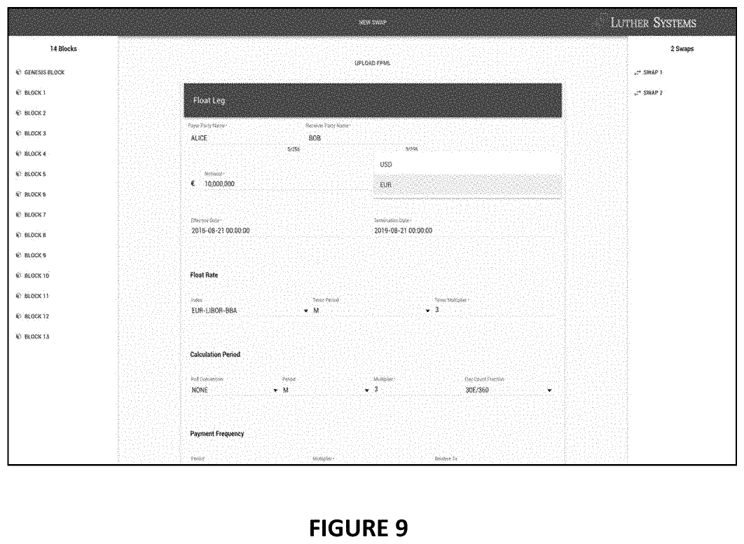

The New Swap View in FIG. 9. enables counterparties to create new IRS smart contracts from a template or upload an existing FPML file. The details of each listed field are described below.

Payer party name (fixed/float): payer counterparty name for the fixed/float leg.

Receiver party name (fixed/float): receiver counterparty name for the fixed/float leg.

Currency (fixed/float): currency the payments are made in for the fixed/float leg.

Effective date (fixed/float): date the first period starts in the contract.

Termination date (fixed/float): last date of the last period in the contract.

Float rate index: Interest Rate Reference curve used to determine floating rates.

Float rate tenor multiplier: tenor on the reference curve used to determine floating rates.

Calculation period roll convention (fixed/float): determines each fixed/float calculation period end date within the regular part of a calculation period schedule. Presently NONE is supported.

Calculation/payment period (fixed/float): period (days or months) for fixed/float payment calculations/payments.

Calculation/payment period multiplier (fixed/float): multiplier of the period for fixed/float payment calculations/payments. The calculation/payment period multiplied by the calculation/payment period multiplier is the length of the payment calculation/payment period.

Payment frequency relative to (fixed/float): Specifies whether payments occur relative to each adjusted calculation period start date, adjusted calculation period end date, or each reset date.

Fixed rate initial value: rate of the fixed leg that is used to compute fixed payment amounts.

Each derivative contract being processes and executed by the system 100 may have one or more derivative contract specification parameters. In the embodiment in which multiple simultaneous derivative contracts are being executed by the system, each derivative contract may have the same or similar contract specification parameters or different contract specification parameters. The contract specification parameters may include, for example, FPML fields such as notional, index name, calculation period, tenor period, etc.

The implementation process consists of 4 stages described in detail below.

Stage 1: Negotiation and Agreement. Initially the counterparties interact with the system using the native application. This application provides a convenient UI that does not require blockchain expertise. One of the counterparties uses the New Swap View to create a new Interest Rate Swap. The user sees a contract template with the swaps contract attributes she can input. Alternatively the user is able to upload an existing FPML file which automatically populates these fields. If necessary the user can make changes to the contract attributes on the platform. Subsequently the contract template is translated into a final FPML file. The native application converts the finalized FPML into a BCML object and sends it to the oracle to deploy on the blockchain.

Stage 2: Deployment. The oracle receives the BCML from the native application and then converts it to chaincode and deploys it on the blockchain. It then immediately issues a query message to the chaincode using the chaincode's ID to retrieve a BCML object that includes the schedule of events. With this approach the schedule of events is entirely generated on the blockchain which reduces errors due to implementation differences for schedule generation as the blockchain is the source of truth. The oracle reads the pending event list specified in the BCML object and then registers a timer for each pending event. When the timer triggers the oracle looks up the contract details to determine what Interest Rate Reference to retrieve the floating rate from. It then uses an external API to retrieve the appropriate Interest Rate Reference and sends this rate along with the current timestamp for this rate to the IRS chaincode identified by the chaincode ID. It sends this message via the blockchain client which issues an invoke message to the chaincode.

Stage 3: Execution. When the chaincode receives an invoke from the oracle it receives a message that includes a timestamp representing the current date and a floating rate needed to calculate float leg payment amount. The chaincode first loads the BCML object from the blockchain. The chaincode then executes all of the relevant pending events for that date, removes them from the pending list and adds them to the past event list. On the UI the counterparties see the pending event removed from the pending list and added to the event history, along with the latest account balances in real time. For fixed/float rate retrieval and payment calculation the past events include the date, retrieved rate, and payment amounts. In the case where two payment events are scheduled on the same day within the original FPML, the chaincode creates a single net event where one counterparty pays the other the difference. This net event includes the date, payer counterparty, payment amount, and counterparty balances. Lastly, the chaincode stores the updated BCML object back on the blockchain.

Stage 4: Completion. The execution continues whereby the oracle sends an invoke message for every pending event and the chaincode executes the pending events for each date as described earlier. This process repeats until either every pending event is executed or a fault event occurs. Once the contract is fully executed the Swap View can be used as essentially the already available contract execution report available on the Blockchain. Any node can query the blockchain to retrieve the BCML object which contains the entire contract details and event history. In the case of fault the counterparties are prompted on the UI with an indication that the contract needs resolution.

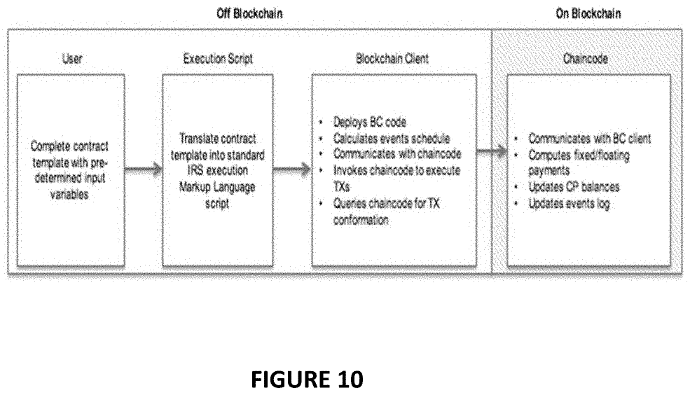

In FIG. 10. the process described is separated into on/off blockchain functionality, where:

Off BC (off block chain):

1. users interact with contract template,

2. template translated into execution script (smart contract parameters),

3. BC client receives the event schedule from the chaincode,

4. invokes the chaincode to execute transaction events,

5. queries chaincode for confirmation.

On BC:

1. chaincode interacts with oracle to receive execution parameters

2. carries out individual transaction events.

FIG. 4. illustrates a variation of the process described above as a flowchart. This flowchart illustrates the entire IRS smart contract lifecycle.

Hyperledger fabric supports execution of smart contracts written in a variety of programming languages including Go and Java. Although the platform is “Turing Complete,” meaning it can run arbitrary programs (similar to Ethereum), there are subtle limitations across all Blockchain architectures that disable several standard programming language features. These limitations along with the unique requirements for IRS result in the design herein.

The chaincode defines handlers, or callbacks, for three types of messages that are sent by clients:

Init is called immediately after a chaincode is deployed. It initializes an IRS BCML object with all the IRS parameters passed by the client and saves this state on the blockchain.

Invoke, or “update”, is called when a client creates a transaction that updates the chaincode. With IRS, the oracle periodically creates a transaction that sends an invoke message with the reference rate to the chaincode. This results in the chaincode (i) executing pending events, (ii) moving them to the event history, and (iii) saving the new state.

Query can be called at any time by clients to retrieve state of the chaincode. Within IRS, the handler returns the entire BCML object which includes all of the IRS parameters, pending events, and past events. After the oracle deploys the contract it issues a query to retrieve the schedule of events computed by the chaincode. It uses this schedule to issue the subsequent invokes at the proper times.

Chaincode must not directly interact outside of the blockchain system, including using any file system operations, network calls, or storing off-chain state. This requirement is necessary for deterministic chaincode execution. Every fully validating node in the network runs an instance of the chaincode program and there are no requirements that nodes have access to the same outside resources. If chaincode could communicate with an outside API directly (e.g., on the Internet) then non-deterministic execution could occur across multiple validators if the API were to become unavailable or provide different values at different times. Non-deterministic execution prevents validators from reaching consensus for the smart contract.

Since there is not a precise clock common to the validators, chaincode cannot use libraries to directly retrieve the current time and they must receive this information via a client who sends an invoke with the date and time (e.g., an Oracle). Similarly, chaincode cannot use “sleep” functionality to schedule an event to trigger in the future, since imprecise and unsynchronized clocks could introduce non-determinism. These limitations imply that a chaincode which requires execution at a future point in time, must be “triggered” by an outside service such as an oracle and provided with the “current time”. Future blockchain architectures may address these limitations by exposing a chaincode API that retrieves the current time using timestamps on the blockchain or by periodically using a consensus algorithm for clock synchronization. Alternatively, one can create an “alarm clock” smart contract that all other smart contracts use for event scheduling, such as in Ethereum with the “Ethereum alarm clock.”

In one embodiment, the initial section of the IRS Smart Contract development consists of code to load and persist state to the blockchain. We used chaintools to greatly reduce the amount of boilerplate code for marshaling and demarshaling messages to and from clients. The system may use google protobufs for all chaincode related messages and chaintools makes processing these messages transparent. In other words, the client can directly send a JS object to the chaincode which then receives a Go object and sends a reply that the client receives as a JS object (where the objects are automatically converted to protobuf messages).

The BCML object is an object that stores all of the contract details including pending and past events. The chaincode is designed so that whenever it receives a query or an update message it immediately loads the BCML object from the blockchain storage. In one embodiment this object is stored as a serialized protobuf. All of the chaincode's execution is performed as a function of only this BCML object. After the execution is complete in the case of an update, then the new object is persisted to blockchain storage as a protobuf. In this way no state is stored off chain thus avoiding the previously discussed issues of non-determinism.

The blockchain is the source of truth for the nodes in the network and should contain as much details about the IRS as possible. Since the oracle is an off-chain service that requires trust by both counterparties the chaincode design should limit the amount of trust in this service. As such, we include the calculation and storage of the entire schedule of events (including past and pending) directly within the IRS chaincode, along with all of the contract details. In this design the oracle provides exactly the minimum functionality required for the chaincode to execute:

I. Future Event Notifications: required as discussed above (there is no “sleep” functionality within chaincode).

II. Interest Rate Reference: necessary since it requires communication with an off-chain API.

As soon as the oracle deploys the chaincode it immediately issues a query to retrieve the schedule of events, i.e., the counterparties not only agree on the contract details but also exactly how the schedule of events are calculated and the event execution is performed. The Oracle then sets timers so that at the appropriate times it sends an invoke message to the chaincode that includes the current timestamp as well as the Interest Rate Reference at that time (by consulting an external API).

The IRS Smart Contract chaincode is robust against incorrect oracle information using a principle that we refer to as monotonicity since conceptually both the oracle and chaincode should never go backwards in time. Since the chaincode stores the complete schedule of events (both pending and past), it can check an invoke message from the oracle to make sure that the message contents is consistent with information that it has previously received. We describe this consistency check below.

If the oracle sends an invoke message that contains a time that is after the next scheduled event then an error has occurred and the contract immediately enters a fault state that requires the counterparties to resolve off-chain. In other words, the oracle missed an event. If the chaincode receives an invoke before the next scheduled event then it is ignored, except if the date is earlier than a previously received date in another invoke then the contract enters a fault state as it suggests an error in the oracle, i.e., the Oracle should never go backwards in time.

If the contract receives two early invokes on the same date with different reference rates then the contract also enters the fault state. This logic enables the smart contract to validate some time information despite it not having access to a clock. Furthermore, the monotonicity design choice easily enables more advanced configurations of oracles (e.g., multiple oracles for redundancy, or each counterparty running their own oracle).

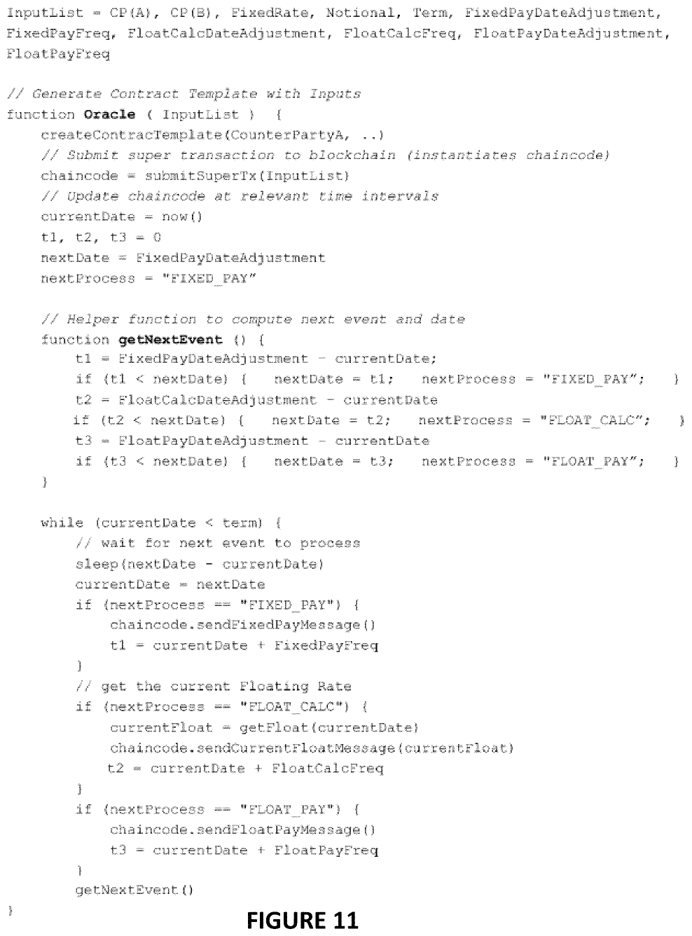

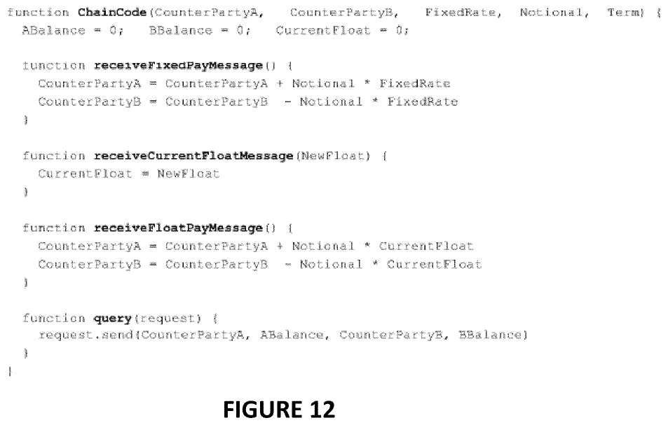

More detailed specifics of the oracle and the initial chaincode algorithms are available as pseudo-code in FIG. 11 and FIG. 12.

The process and design of the first iteration of an IRS smart contract processing and execution platform are disclosed above. Many further extensions and improvements of this process are possible depending on client requirements.

Blockchain technology must scale to meet the demands of enterprise applications as they grow. Exact system requirements will depend on the asset class and each customer's use case. Enterprise departments formalize these requirements and guarantees through Service-level Agreements (SLAs) which is a contract between an infrastructure provider (e.g., IT) and a customer (e.g., swap processing department) that specifies the expected level of performance and responsibilities of both parties.

New transaction processing systems that integrate with Blockchain technology require an extensive evaluation with real and simulated workloads to better understand any scaling limitations and assign SLAs. I.e., to understand how the system behaves as more transactions, nodes and users are added to the network. Although existing Blockchain infrastructures can meet the requirements of certain financial applications today, we believe that additional extensions are necessary for Blockchain to process typical workloads for certain asset classes like IRS. We identify and discuss two such scaling dimensions below.

Transaction throughput measures the number of transactions processed per second (tps) and is measured both as an average and maximum. A related measurement is transaction processing delay which is the average and maximum delay for transaction processing in seconds or milliseconds. Existing systems may process an several tps to tens of thousands tps depending on the asset class. Increasing throughput beyond a threshold often also increases processing delays.

Blockchain infrastructure groups transactions within blocks which are then confirmed by nodes running the consensus protocol. As such, maximum transaction throughput in blockchain infrastructure is bounded by limits such as the maximum transactions within a block and the consensus protocol execution delays. Transaction validation requires every node to execute and validate every transactions which introduces additional delays in achieving network consensus. Extensions are needed that improve the performance of the consensus protocols and chaincode execution before blockchain infrastructure can achieve the throughput requirements of certain asset classes.

Blockchain infrastructure requires every node to execute and validate every transaction and execute a consensus protocol. This requirement provides security guarantees but introduces inefficiencies as the number of network nodes grows. Permissioned vs permissionless blockchain infrastructures make different design tradeoffs where typically permissionless technologies support a larger number of nodes (e.g., thousands to tens of thousands) at a lower transaction throughput, and permissioned technologies support higher transaction throughput with a smaller number of nodes. For certain asset classes consensus protocol extensions are needed that provide a middle ground that support medium-to-high transaction throughput with a low-to-medium number of nodes.

Two nodes transacting on a Blockchain may not want other nodes to “know” the contents of the transaction and in some cases may not want other nodes to even “know” their identity as having participated in that transaction.

Depending on the system configuration, additional mechanisms may be necessary to ensure transaction confidentiality. In the configurations described in this document every peer validates every transaction which means that they see all of the IRS transaction details. Transaction confidentiality is an active Blockchain research area and there are several approaches that have different security requirements. Luther Systems has developed a proprietary approach that involves execution of the contract off chain by counterparties and auditors, while execution validation occurs on chain. This approach ensures that only the parties involved with the contract can view the contract details while the execution is validated using the strength of the entire blockchain network.

The described system must integrate with existing systems in a production enterprise deployment. These details depend on a variety of customer requirements and considerations. We list some of the key integration factors below. Some of these considerations are not specific to blockchain in particular, but are necessary for any software deployment in enterprise.

On vs. off premise deployment strategy (e.g., private or public clouds).

Networking security (e.g., VPNs, IPSEC, Intrusion Detection System rules, firewall rules and traffic characteristics).

User authentication and identity management integration for blockchain peers, clients and physical hardware (e.g., 2FA, OAuth, SAML2, PM, API gateways).

Blockchain software compliance with existing company policies.

Reporting and analytics integration (e.g., rsyslog, logstash, tableau).

Integration with existing Network Operations Center (NOC), including heartbeat endpoints and automated health monitoring.

Interface of blockchain technology within existing pipelines (e.g., exposed APIs, REST, SOAP, reliable message passing, databases, files).

Blockchain is a new technology and a multiphase approach is necessary to successfully integrate into an enterprise environment. Each additional phase should increase the amount of integration and an extensive evaluation is necessary at the end of each phase to assess costs, risks, and performance. Initially blockchain technology should be deployed in a shadow chain configuration. As a shadow chain the blockchain ingests and processes live data but operates entirely out of the production critical path. For example, multiple nodes may be deployed and an event stream from the production process is copied and routed through the blockchain as if it were live in production. This approach enables performance analysis of the technology using real world data without the risks of disrupting the production operations. Although a shadow chain cannot take advantage of all of the efficiencies of a full integration it can enable many of the auditing and reporting benefits.

Data standards are necessary for low cost system integration and efficient contract processing in Enterprise. As a new technology there are a growing number of market participants and frameworks that have been designed separately but now require interoperability within enterprise environments. If possible blockchain infrastructures should be fully compatible with any relevant existing industry standards, i.e. FPML for IRS. In some cases existing standards should be extended to include gaps where blockchain provides new functionality not already covered by a specification.

Ideally the past events and pending events that are presently stored in BCML would be saved directly in FPML or some other standard format. A FPML contract implicitly defines a schedule of events that are “supposed/scheduled to happen”. However we need to be able to amend a contract with what actually “does happen” in a standard format, so we can “read it in” later and share it in standard format, the same way we can share a standard FPML file. Similarly, the execution details themselves which are presently defined within the ISDA operating guide can be written in a formal and declarative programming language that is standardized along with FPML. This approach ensures the correct execution of IRS contracts on any compliant smart contract execution platform.

An extensive and thorough evaluation is required to accurately understand the tradeoffs and different design decisions discussed in this document. The performance of a Blockchain architecture can be evaluated based on a number of qualitative and quantitative metrics described below.

Submission Throughput: maximum number of transaction submissions per second possible/permitted by each node and by the entire network.

Maximum/Average Validation Throughput: maximum/average number of transactions/blocks validated per second possible/permitted by the network. This parameter determines the maximum/average transaction processing speed of the network.

Average Transaction Validation Latency: the average length of time it takes for a transaction to be validated from the time of submission. This parameter determines how long on average a user needs to wait for their transaction to be validated and placed in a block. Note that the notion of validation and block confirmations might vary for each Blockchain.

Latency Volatility: the volatility of transaction validation latency. This is a measure of how varied the transaction processing time could be.

Security: system security evaluation requires a threat model that defines the types and scope of adversaries and attacks on the system. Threat models vary across Blockchain applications. A security evaluation may include analysis of:

Transaction and block immutability

Transaction censorship resistance

Denial of Service (DoS) resilience

Trust requirements of users and oracles

Protocol governance and node membership services

Transaction confidentiality and user anonymity.

Confidentiality: Two nodes transacting on a Blockchain may not want other nodes to “know” the contents of the transaction and in some cases may not want other nodes to even “know” their identity as having participated in that transaction.

Transaction fees: In many of the technologies users must pay a small transaction fee to the network in order to process transactions or execute smart contracts. These fees support the maintenance costs of the Blockchain and provide protection from frivolous or malicious computational tasks such as spam transactions or infinite loops in smart contracts.

Operating costs: An aggregate metric to quantify the fixed and recurring costs of maintaining the blockchain system.

Integration costs: An aggregate metric to quantify the cost of integrating the blockchain into existing customer pipelines and services.

Hardware requirements:

Memory/storage: total memory/storage capacity required per node

Processor: amount of processing resources required to validate transactions and blocks

Network usage over time, including throughput and latency requirements

Hardware requirements will change as the network scales

Scalability

Number of nodes: system performance change as the number of nodes increases

Number of transactions: system performance change as the number of transaction submissions per second increases

Number of users: system performance change as the number of active users submitting transactions increases

Geographic disbursement: system performance change as the geographic disbursement of nodes increases

Validation process: not a performance metric but an important factor in determining the performance of the network.

Complexity: a measure of the development, maintenance, and operation complexity of Blockchain infrastructure.

Smart-contract limitations: what the code deployed on the Blockchain can and cannot do, this is influenced by the smart contract scripting language and the underlying consensus protocols.

The chaincode already includes some mechanisms to validate messages received from the oracle. In the same way, additional verification and validation can be included within the oracle to provide additional safeguards on the execution of the chaincode. Since the blockchain is the source of truth, this additional check would primarily be used to generate an exception or flag for an end user to then investigate the discrepancy and possibly issue a halt override. Existing software verification tools can be applied to blockchain technology to verify the correct implementation and execution of standardized blockchain protocols and smart contracts.

One role of the oracle is to notify the smart contract of the current time in order to trigger an event. This functionality can be moved entirely on the blockchain using an approach similar to Ethereum's alarm clock. In this case, a single alarm clock smart contract exists on the blockchain that any other smart contracts can use to register wakeup alarms. An off chain oracle informs this alarm clock of the current time periodically in the same way the oracle informs the IRS smart contract described in this document. The advantage of this approach is that the oracle only sends an update to a single smart contract on the entire blockchain. By enabling other smart contracts to “ask” the alarm clock smart contract “what time it is” it essentially makes the entire blockchain environment “smarter” and more self sufficient. This reduces the need for external oracles.

There are a large number of commercial, execution, regulatory and legal topics related to the derivatives contracts eco-system not covered in this document. For the successful implementation of derivatives contracts via Blockchain technology, the topics below need to be further addressed and resolved before full-scale implementation can occur:

Counterparty Default

Schedule adjustments: Payment Grace Period

Data revision

Netting

Collateral (valuation)

Margining

Contract

Master Agreement

Data Standards

Legal

Jurisdiction

Data protection, ownership, leaving EU

Regulators

Dodd Frank/EMIR

What should the regulators be able to see?

How are swaps regulated?

Who oversees/regulates swaps today?

Current process for creating a swap contract

How long does that process take?

What software is used?

Which companies build it?

Swaps Trading

Trade Volume
Primary market
Secondary market

Secondary Market
dynamics, players, transfer of ownership, . . .
Confidentiality in secondary markets

Trades reporting and execution today

SEF/SDR/C SD

FIG. 11. lists the pseudocode for an initial prototype of the IRS oracle. The oracle is implemented in NodeJS and uses the Hyperledger fabric REST API to send invoke messages to the chaincode. The process logic is broken down into the following steps described below.

Step 1: On creation of the IRS, the contract template is generated with the known input attributes.

Step 2: The contract is then submitted onto the permissioned blockchain (SubmitSuperTx).

Step 3: At relevant time intervals determined by the IRS schedule of events the oracle sends messages to the chaincode.

FIG. 12. lists the pseudocode for an initial prototype of the IRS chaincode that is executed on the hyperledger fabric blockchain. “receive . . . 0” is called by the corresponding “send . . . 0” from NodeJS. The actual chaincode implementation contains many more details including state machine checks, entire IRS details, pending events, past events, and account balances.

In one embodiment the oracle only sends a single event that includes the rate and current time and the chaincode determines which events to execute (e.g., payment calculation, net payment). Also the chaincode performs net payments when float and fixed payment dates are the same.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A system, comprising:
a plurality of distributed ledger nodes that operate in a peer to peer network, each distributed ledger node being a computer system that hosts a blockchain component that stores a distributed ledger shared between the plurality of distributed ledger nodes that stores transactions and a smart contract for a derivative contract; and
a management computer system, connected to each of the plurality of distributed ledger nodes, the management computer system having a processor, memory and a plurality of lines of instructions configured to:
negotiate, using the distributed ledger, a derivative smart contract between one or more counterparties without a trusted third party; and
execute, using the distributed ledger, the negotiated derivative smart contract without a trusted third party.

2. The system of claim 1, wherein the management computer system simultaneously negotiates and executes multiple financial derivative contracts.

3. The system of claim 2, wherein each financial derivative contract has different counterparties and different contract specification parameters.

4. The system of claim 1, wherein the financial derivative contract further comprises one or more contract specification parameters.

5. The system of claim 4, wherein the one or more contract specification parameters include one or more of a notional, an index name, a calculation period, a tenor period.

6. The system of claim 4, wherein the management computer system is further configured to translate the one or more contract specification parameters into a set of smart contract parameters.

7. The system of claim 1, wherein the management computer system is further configured to generate a list of one or more events, wherein the one or more events include one of a pending schedule of events and past executed events.

8. The system of claim 7, wherein the one or more events capture derivative contract execution details.

9. The system of claim 8, wherein the derivative contract execution details include one or more of a fixed rate/payment calculation, a float rate retrieval and float payment calculation and a net payment.

10. The system of claim 1 further comprising an oracle service external to the smart contract connected to a network to which the plurality of distributed ledger nodes and the management computer system is connected, wherein the management computer system is further configured to reliably and securely coordinate a periodic collection of derivative contract information from the oracle service.

11. The system of claim 10, wherein the derivative contract information from the oracle service further comprises a derivative contract floating rate.

12. The system of claim 1, wherein the system, using the generated smart contract, periodically computes and triggers net payments between the one or more counterparties.

13. The system of claim 1, wherein the system, using the generated smart contract, maintains an account balance for each of the counterparties.

14. The system of claim 4, wherein the management computer system is further configured to one of receive the one or more contract specification parameters through a graphical user interface, receive the one or more contract specification parameters uploaded using a contract specification format and receive the one or more contract specification parameters from an external source over an application programming interface.

15. The system of claim 1, wherein the management computer system is further configured to permanently record the derivative contract in the distributed ledger.

16. The system of claim 1, wherein the management computer system is further configured to permanently record each execution step of the derivative contract that is verified by each counterparty's distributed ledger node.

17. A method, comprising:
providing a plurality of distributed ledger nodes that operate in a peer to peer network, each distributed ledger node being a computer system that hosts a blockchain component that stores a distributed ledger shared between the plurality of distributed ledger nodes that stores transactions and a smart contract for a derivative contract;
negotiating, using the distributed ledger, a derivative smart contract between one or more counterparties without a trusted third party; and
executing, using the distributed ledger, the negotiated derivative smart contract without a trusted third party.

18. The method of claim 17 further comprising simultaneously negotiating and executing multiple financial derivative contracts.

19. The method of claim 18, wherein each financial derivative contract has different counterparties and different contract specification parameters.

20. The method of claim 17, wherein the financial derivative contract further comprises one or more contract specification parameters.

21. The method of claim 20, wherein the one or more contract specification parameters include one or more of a notional, an index name, a calculation period, a tenor period.

22. The method of claim 20 further comprising translating the one or more contract specification parameters into a set of smart contract parameters.

23. The method of claim 17 further comprising generating a list of one or more events, wherein the one or more events include one of a pending schedule of events and past executed events.

24. The method of claim 23, wherein the one or more events capture derivative contract execution details.

25. The method of claim 24, wherein the derivative contract execution details include one or more of a fixed rate/payment calculation, a float rate retrieval and float payment calculation and a net payment.

26. The method of claim 17 further comprising reliably and securely coordinating a periodic collection of derivative contract information from an oracle service.

27. The method of claim 26, wherein the derivative contract information from the oracle service further comprises a derivative contract floating rate.

28. The method of claim 17 further comprising periodically computing and triggering net payments between the one or more counterparties.

29. The method of claim 17 further comprising maintaining an account balance for each of the counterparties.

30. The method of claim 20 further comprising one of receiving the one or more contract specification parameters through a graphical user interface, receiving the one or more contract specification parameters uploaded using a contract specification format and receiving the one or more contract specification parameters from an external source over an application programming interface.

31. The method of claim 17 further comprising permanently recording the derivative contract in the distributed ledger.

32. The method of claim 17 further comprising permanently recording each execution step of the derivative contract that is verified by each counterparty's distributed ledger node.
